(19) United States
(12) Patent Application Publication
(10) Pub. No.: US 2014/0117730 A1
(43) Pub. Date: May 1, 2014

(54) Scooter Slipcover

(71) Applicant: Myra Olive Hoefer, Healdsburg, CA (US)

(72) Inventor: Myra Olive Hoefer, Healdsburg, CA (US)

(21) Appl. No.: 14/146,899

(22) Filed: Jan. 3, 2014

(51) Int. Cl. B60N 2/60; A47C 7/66

(52) U.S. Cl. CPC B60N 2/60; A47C 7/66
USPC 297/228.1

(57) ABSTRACT

A removable slipcover for a chair on a mobility device such as a mobility scooter or rolling assembly. The slipcover fits over the seat, chair back and arms and does not require attachment straps or elastic means for retention. The present slipcover may include a skirt portion that aids in concealing the chair post of the mobility scooter without extending to or interfering with the wheels of the mobility scooter or rolling assembly. The present slipcover may include cushioning on the seat portion for added comfort, and pockets for added carrying or storage capability. The present slipcover may include ornamentation for aesthetic or advertising purposes. A matching cover for a steering column may be included if desired.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable,

### BACKGROUND OF THE INVENTION

1. Field of the Invention

The present invention relates generally to covers and protectors for various articles. More specifically, the present invention relates to a protective slipcover for a mobility scooter chair or similar seat.

2. Description of the Related Art

The mobility scooter is an electric three or more wheeled vehicle with a seat and front steering column designed to allow people with limited mobility to move independently from place to place. It has become increasingly popular for those who have difficulty with mobility or who have limited endurance that prohibits extended walking or standing. Those who use the mobility scooter often rely heavily on its use and use it not only to move around their homes, but also for transportation while shopping, running errands, visiting with friends, and as an alternative to walking when enjoying the outdoors. In addition, many stores and entertainment venues such as amusement parks are now offering mobility scooters for shoppers to allow them to easily maneuver through the store or around the grounds while shopping or sight-seeing, and to shop or stay for longer durations without tiring.

Due to its often extended use, the seat and arms of the scooter may experience significant wear and tear. In addition, the arms may be exposed to the sun for extended periods, and the arm and seat may be exposed to the elements for extended time while the scooter is parked outside and not in use. Some manufacturers offer a sun-shade accessory that will help to protect the user when riding, and the seat and arms when parked, but these sun shades are often an awkward addition that can inhibit transportation of the mobility scooter in a vehicle, and do not provide full protection for the arms and seat when the sun is not directly over head.

For users with limited mobility, the operator may spend extended amounts of time remaining seated in the scooter while doing normal daily activities around the house or when shopping, visiting, running errands, and the like. Due to the extended time in substantially the same position, the operator may find the seat to become uncomfortable. In addition, the operator may experience perspiration, resulting in moisture in the operator's garments that are pressed between the operator and the scooter seat and back. The moisture absorbed by the garments stays in contact with both the skin and scooter, which can cause skin irritation, damage to the operator's clothing and/or damage to the scooter seat and back surfaces. For scooters that are used by multiple users, such as those available in stores and entertainment venues, this can become a concern due to questionable cleanliness of the scooter for the next patrons.

In addition to the problems discussed above, most scooters lack in aesthetics. For example, a scooter seat and back are generally formed from a vinyl, or leather material, typically in a solid dark blue or black. For those individuals who require a scooter for mobility, the appearance can seem quite cheerless. It is known that color can impact mood, appetite and even energy level. Indeed, years of color response research have shown that certain colors elicit specific and often strong responses. For example, particular colors, such as blues and greens can promote mental balance and physical well-being, and encourage rest and solitude. Other colors, such as red, orange and yellow, inspire vitality, courage, happiness, passion, and so forth. Often individuals will wear a particular color of clothing in an attempt to affect their emotions or project their current emotional state. As an extension to wearing particular colored clothing to affect or project mood, it is desirable to be able to readily change the color of a user's mobility scooter for the same purpose and/or to complement the operator's clothing.

The foregoing problems with wear and tear, comfort, and aesthetics can be resolved with a removable slipcover. Slipcovers have been used for many years to protect furniture, to make seating more comfortable and visually appealing, or to provide for cleanliness. Generally, these articles were made for sofas and chairs. Slipcovers have also been designed for use for automobile seats, airline seats and other seats encountered in transportation for essentially the same purposes. However, a disposable slipcover that meets the needs for use with a mobility scooter has not been developed. To accommodate the special needs of a mobility scooter, the slipcover must not interfere with the wheels or driving mechanism, be easy to install and remove, provide for protection of the arms, and, in a preferred embodiment, allows access to the adjustment mechanisms located under the seat. Such a slipcover could also be used for protection, comfort, and/or improved aesthetics of any chair that is mounted on a post and has some mobility feature at its base, such as an office chair or home lift chair.

A discussion of the related art of which the present inventor is aware, and its differences and distinctions from the present invention, is provided below.

U.S. Pat. No. 7,240,964 discloses a Universally Adjustable Slipcover for dining room chairs that provides a form-fitting cover which accommodates the arms, but does not cover the arms for protection as the present invention is designed to do. Also, it requires extensive assembly which is not compatible with the use of a mobility scooter, wherein easy installation and removal of the slipcover is desirable. U.S. Patent Application No. 2012/0313410 discloses a similar version which is disposable, but also does not provide protection for the chair arms.

U.S. Pat Application No. 2013/0113251 discloses a Home Office Chair Cover that is form fitting. Although this invention also discloses protective covers for the arms of the chair, those covers are separate from the back and seat covers, and therefore require additional assembly due to the form-fitted shape. Even if it could be adapted to the specific shape of a motor scooter, attachment and removal of the entire assembly would be cumbersome due to the multiple pieces. In addition, the form-fitting nature would make manufacturing more expensive as the product must be uniquely designed for each and every model of motor scooter or other chair.

U.S. Pat No. 6,155,637 discloses a Slipcover for Glider Rockers that covers the entire chair, but also includes means for attachment to the chair to prevent slippage of the material when the occupant is seated. This slipcover extends to the base of the furniture, or to the floor. These characteristics of design, although desirable for furniture, are not suitable for a mobility scooter due to the need to accommodate the driving wheels and not interfere with the drive mechanism underneath. In addition, attaching the slipcover to the seat is not desirable as the slipcover would then be difficult to remove for cleaning, replacing, or changing the aesthetic appearance of the scooter, especially for some users of the scooter who have limited mobility.

U.S. Pat No. D-331,346 discloses an ornamental design for a Furniture Cover that accommodates and covers the arms, but also extends substantially to the ground with additional material around the skirted bottom portion. As mentioned previously, this is not suitable for a mobility scooter due to the need to ensure no fabric of the cover interferes with the wheels or drive mechanism, and due to the desirability of allowing access to the seat adjustments.

U.S. Pat No. 7,857,384 discloses a Semi-custom Fit Slipcover that covers arms, seat and back of a piece of furniture. This slipcover, however has pleated seams and elastic that allows it to expand over the larger portions of the furniture. This type of complexity is expensive for manufacture and is not useful for a mobility scooter, wherein the elastic would become a burden under the seat, and the pleating results in excessive material that would inhibit installation on a simple motor scooter chair.

U.S. Pat Application No. 2013/0320720 discloses a disposable protective slipcover for promotion and advertising that provides easy removability, but whose protection is limited to only the head-rest portion of a seat. That invention, however, does not address the full protection for the arms and seat desirable for a mobility scooter application.

U.S. Pat Application No. 2007/0069560 disclosed a Seat Cover with Storage for a Motorized Wheelchair or Scooter, which is comprised of components that are removable for cleaning. This invention, however, is made of separate components that are attached with straps, making installation and removal cumbersome. The invention disclosed herein provides all protection for the seat, back, and arms in a single piece which improves ease of use and avoids the problems associated with attachment straps.

None of the above inventions is seen to describe the present invention which defines an easily removable slipcover that is suitable for use with a mobility scooter.

### BRIEF SUMMARY OF THE INVENTION

The object of the present invention is to provide an easily removable slipcover that fits over a mobility scooter to improve longevity, and provide comfort, cleanliness, and a visually appealing chair seat while allowing adjustment of the scooter seat, and while not impeding the operation of the scooter. The design is such that the fabric or material of the cover remains above the wheels and driving mechanism, but also offers some visual concealment of the chair post. An advantage of the present invention is the simplicity with which it can be installed and removed, and the ease with which it can be changed to another to match the user's mood or spirit, or to provide a fresh cover for a new user where the mobility scooter may be used by more than one person. The slipcover may include storage pockets for carrying capacity, cushions for comfort, and/or a matching cover for the steering column section of the scooter to improve aesthetics and carrying capacity. The slipcover and/or steering column cover may also be decorated with trim or designs, or used to display advertisements as would be desirable in a commercial retail environment.

The present invention comprises a slipcover designed to be loosely form-fitting for the chair of a mobility scooter that covers the scooter chair seat, back, and arms. The present invention is comprised of one or more elements that are sewn or otherwise attached together to form a solid piece that is open at the bottom so it is easily installed by simply dropping it over the chair of the mobility scooter. The slipcover may have a skirt portion that extends below the seat level such that it provides an aesthetically pleasing appearance without preventing access to the seat adjustment devices. The slipcover remains in place by its own weight, so no attachment devices or alterations to the scooter or chair are required. An optional cover for the steering column section is also included which serves to improve the overall aesthetics of the mobility scooter by concealing the drive post with matching fabric or material.

The slipcover may be made of particular materials for specific purposes. For example, a slipcover intended for extended use by a single user may be made from upholstery fabric that is designed to withstand significant wear and tear, or absorb perspiration, while a slipcover intended to be used once in a retail store and then disposed of may be made of a lighter weight fabric, or even a durable paper or plastic product. In addition, the slipcover may include at least one permanent or removably attachable storage pocket, and for added operator comfort, the slipcover may include at least one permanent or removably attachable cushion, or other support device. A matching steering column cover may also be provided for aesthetic purposes and/or to provide additional storage capacity if it has attached pockets. Finally, this slipcover may be used for other seats that are supported by a post and have some mobility mechanism at the base, such as office chairs.

### BRIEF DESCRIPTION OF THE SEVERAL VIEWS OF THE DRAWINGS

A more complete understanding of the present invention may be derived by referring to the detailed description and claims when considered in connection with the Figures., wherein like reference numbers refer to similar items throughout the Figures and:

FIG. 1 is a perspective view of the slipcover as installed on a mobility scooter.

FIG. 2 provides various views of the slipcover, and wherein FIG. 2A is a front view, FIG. 2B is a side view, and FIG. 2C is a rear view.

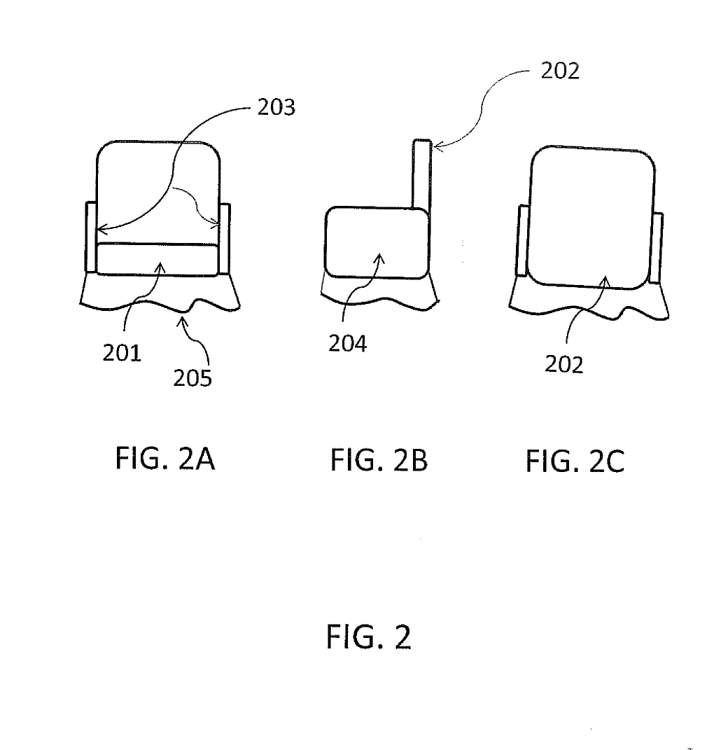

FIG. 3 provides a front view of the slipcover as installed on a mobility scooter seat.

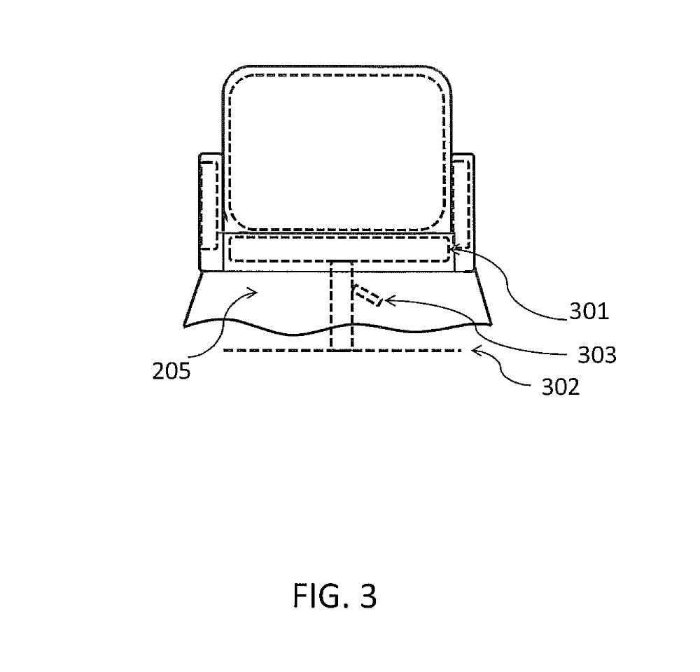

FIG. 4 shows the optional steering column cover, wherein FIG. 4A is the cover viewed as installed on the steering column from the operator's point of view. FIG. 4B is a side view of the steering column cover.

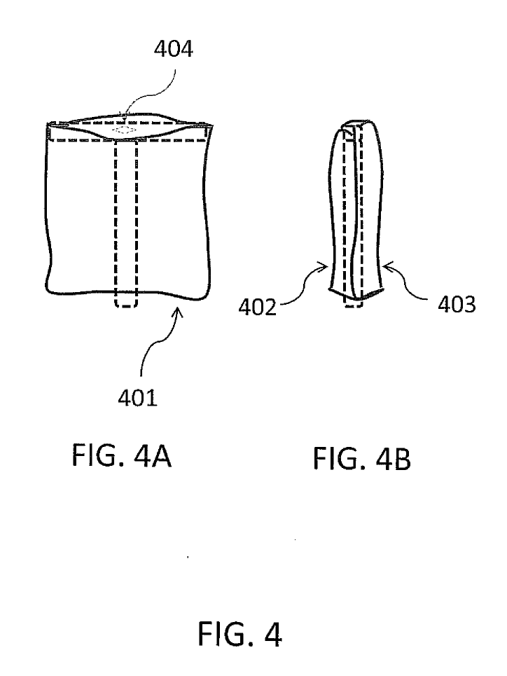

FIG. 5 is a perspective view of the slipcover with the optional steering column cover installed on a mobility scooter.

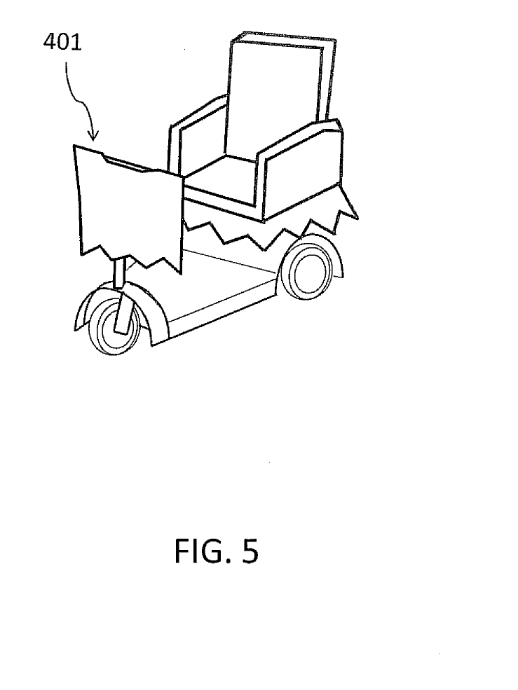

FIG. 6 is a front view of the slipcover as installed on an office chair.

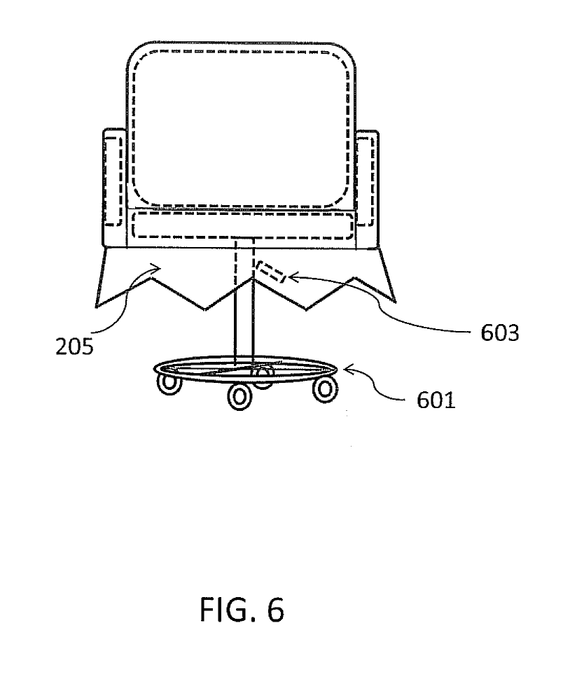

### DETAILED DESCRIPTION OF THE INVENTION

In the following detailed description of the invention, reference is made to the accompanying drawings which form a part of the disclosure and, in which are shown by way of illustration, and not of limitation, specific embodiments by which the invention may be practiced. The drawings, the foregoing discussion, and the following description are exemplary and explanatory only, and are not intended to limit the scope of the invention or this application in any manner.

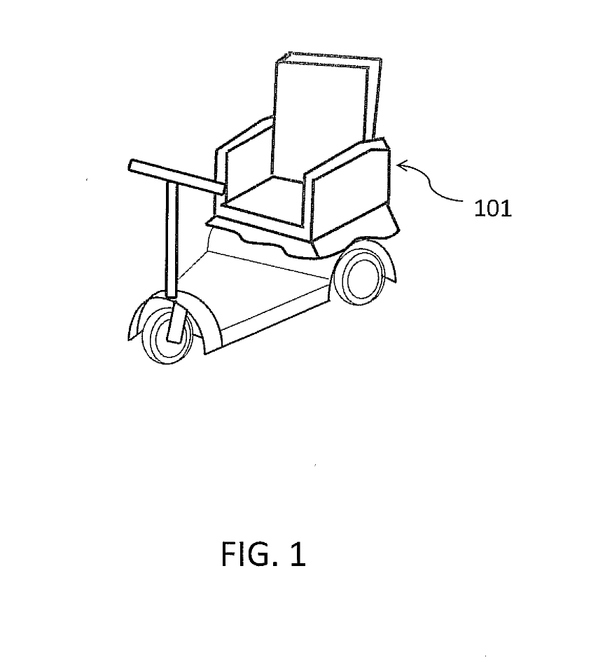

The present invention comprises a slipcover 101 for a chair, such as that on a mobility scooter or the like, with the slipcover having a general configuration substantially as shown in FIG. 1. In a preferred embodiment, the slipcover 101 includes at least a seat cover 201, a chair back cover 202, two inner arm covers 203, and two outer arm covers 204. The seat cover 201, chair back cover 202, inner arm covers 203, and outer arm covers 204 may each be made of a single piece or two or more pieces that are connected together. In an alternate configuration, two or more of the said covers may be made from a single piece of material. The seat cover 201, the back of the chair back cover 202, and outer arm covers 204, extend downward to at least the bottom of the chair seat 301. An optional skirt portion 205 may be attached to the bottom of the seat cover 201, the back of the chair back cover 202, and/or outer arm covers 204 to provide additional decorative effect. The skirt portion 205, may be a separate piece, or, alternately, may be comprised of extensions of the seat cover 201, the back of the chair back cover 202, and/or the outer arm covers 204. The skirt portion terminates above the top of the mobility scooter wheel hubs 302, or the chair mobility means 601. The skirt portion 205, whether comprised of a separate piece, or extensions of one or more of the seat cover 201, chair back cover 202, and/or outer arm covers 204, may have a scalloped, triangular, or other non-linear decorative shape; may be made from fringe, or may be made from separated panels such that the skirt 205 can be easily reached under or through so the user can access the seat adjustment devices 303 located on the shaft under the mobility scooter seat 301, or the seat adjustment devices 603 located on the shaft under an office chair. An optional matching cover 401 for the steering column may also be included for additional decorative effect.

In an alternate embodiment, the slipcover may include a cushion (not shown) for user comfort that is permanently or removably attached to the underside of the seat cover 201. Removable attachment means may be through use of snaps, hook and loop closures, or the like. In an alternate embodiment, the slipcover may include a cushion (not shown) that may be attached to the inside or outside of the front of the chair back cover 202 just above the seat cover 201 for user comfort in the way of lumbar support.

In a preferred embodiment, the optional steering column cover 401 comprises a front section 402 and a back section 403 that are connected on the outer edges at the top such that the mobility scooter controls 404 are fully accessible by the operator. The front section 402 and back section 403 may be made of one or more pieces of fabric or material.

In a preferred embodiment, the slipcover includes at least one permanent or removable pocket (not shown) attached to one or both of the inner arm covers 203, the outer arm covers 204, the back of the seat back cover 202, or the front or back of the steering column cover 401. Removable attachment means may be through the use of snaps, hook and loop closures, or the like.

Many modifications and variations of this invention can be made without departing from its spirit and scope, as will be appreciated by those skilled in the art. For example, seams may be trimmed with piping for aesthetic affect, design elements such as fringe, or lace may be added to enhance aesthetics or customize to match the user's personality. In addition, if the optional lumbar support cushion (not shown) is added, it may be made from a bladder that is adjustably filled with air by the operator for maximum comfort. The specific embodiments described herein are offered by way of example only. The embodiments were chosen and described in order to best explain the principles of the invention and its practiced applications.

I claim:

1. A removable protective cover for a chair on a mobility scooter, comprising:
a slipcover having at least a seat cover portion, a forward chair back cover portion, a rearward chair back cover portion, two inside arm cover portions, and two outside arm cover portions; said slipcover covering the entire seating portion of the chair and arms when installed thereon; and
a separate slipcover for the steering post of the mobility scooter that has an opening at the location of the mobility scooter controls.

2. The removable protective cover according to claim 1, further comprising at least one pocket attached to at least one of the inside or outside arm cover portions, the chair back cover portion or the steering post slipcover, wherein the means for attaching at least one pocket is selected from the group consisting of cooperating snap fasteners for a removable attachment, cooperating hook and loop material for a removable attachment, sewing for a permanent attachment, or bonding for a permanent attachment.

3. The removable protective cover according to claim 1, further comprising a decorative skirt portion that extends below the seat on at least one side of the cover.

4. The removable protective cover according to claim 2, further comprising a decorative skirt portion that extends below the seat on at least one side of the cover.

5. A removable protective cover for a chair whose base is a post attached to mobility means, comprising a slipcover having at least a seat cover portion, a forward chair back cover portion, a rearward chair back cover portion, two inside arm cover portions, and two outside arm cover portions; said slipcover covering the entire seating portion of the chair and arms when installed thereon.

6. The removable protective cover according to claim 5, further comprising at least one pocket attached to at least one of the inside or outside arm cover portions, or the chair back cover portion, wherein the means for attaching at least one pocket is selected from the group consisting of cooperating snap fasteners for a removable attachment, cooperating hook and loop material for a removable attachment, sewing for a permanent attachment, or bonding for a permanent attachment.

7. The removable protective cover according to claim 5, further comprising a decorative skirt portion that extends below the seat on at least one side of the cover.

8. The removable protective cover according to claim 6, further comprising a decorative skirt portion that extends below the seat on at least one side of the cover.
